(19) United States
(12) Patent Application Publication
(10) Pub. No.: US 2004/0197097 A1
(43) Pub. Date: Oct. 7, 2004

(54) Optical signal quality monitoring system and method

(76) Inventors: John D. Downie, Painted Post, NY (US); Christophe Nicolas, Bicetre (FR); Trent Coroy, Rancho Cucamonga, CA (US)

Correspondence Address: CORNING INCORPORATED, SP-TI-3-1, CORNING, NY, 14831

(21) Appl. No.: 10/405,686

(22) Filed: Apr. 1, 2003

(51) Int. Cl. H04B 10/08

(52) U.S. Cl. 398/27

(57) ABSTRACT

An optical signal quality monitoring system and method are provided for monitoring signal quality of a plurality of optical signals in a network. The system includes a plurality of input taps for acquiring multiple optical signals from multiple optical fibers of an optical network. The system also includes an optical switch for receiving the tapped optical signals and selecting one of the tapped optical signals at a time as an output, and an optical channel selector for selecting one signal channel at a time of the selected optical signal. The system further includes an optical signal quality measurement device for analyzing the selected optical channel of the selected optical signal and determining a signal quality of the selected optical channel.

### BACKGROUND OF THE INVENTION

1. Field of the Invention

The present invention generally relates to quality monitoring of optical signals and, more particularly, relates to a system and method of non-intrusively monitoring the signal quality of digital signals in optical networks.

2. Technical Background

Data communication systems commonly employ fiber optic cable (optical fibers) coupled to optical devices (e.g., photonic devices) for communicating information with optical signals. It is generally required to test the optical signals in a communication line or device in order to ensure that the quality of optical signals is sufficient for the intended applications. The quality of an optical signal, such as the optical signal-to-noise ratio, can be measured in different ways and with a number of known monitoring techniques. One such technique for determining quality of an optical signal estimates the Q-factor of the signal. Another technique for measuring quality of an optical signal measures the bit error rate (BER) of the optical signal. By determining the Q-factor and/or bit error rate of an optical signal, a monitoring device can determine the signal quality of the digital signal.

Some conventional optical communication systems typically employ a combination of optical and electrical circuit components, including a plurality of transmitters and receivers, for performing optical-electrical-optical conversions. These types of conventional network systems typically convert an individual optical signal to an electrical signal in a plurality of locations along the signal path, at least partially to accommodate for measurement and determination of the signal quality in the electrical state. The electrical signal is subsequently reconverted to its optical state and is transmitted back into the optical signal path (e.g., optical fiber). The requirement of electrical conversion circuitry, including the transmitters and receivers adds to the overall cost of the network.

Some monitoring systems have been proposed that determine signal quality of an individual optical signal. This can be accomplished by performing one of a number of known signal quality measurement techniques including analyzing amplitude histograms of the optical signal. While many conventional optical signal quality monitoring devices are able to monitor the signal quality of a given optical signal, many systems cannot efficiently handle multiple signals typically present in an optical network having many optical channels.

Accordingly, it is desirable to provide for an optical signal quality monitoring system that is capable of efficiently monitoring a plurality of optical signal channels present in an optical network. It is further desirable to provide for a reduced cost and size optical quality monitoring system.

### SUMMARY OF THE INVENTION

In accordance with the teachings of the present invention, an optical signal quality monitoring system is provided for monitoring signal quality of a plurality of optical signals in a network. The system includes a plurality of input taps for acquiring multiple optical signals from multiple optical fibers of an optical network. The system also includes an optical switch for receiving the tapped optical signals and selecting one of the tapped optical signals at a time as an output, and an optical channel selector for selecting one signal channel at a time of the selected optical signal. The system further includes an optical signal quality measurement device for analyzing the selected optical channel of the selected optical signal and determining a signal quality of the selected optical channel.

According to another aspect of the present invention, a method of monitoring optical signal quality of multiple optical fibers in a network is provided. The method includes the step of acquiring multiple optical signals from multiple optical fibers in a network, and selecting one of the tapped optical signals at a time. The method also includes the step of selecting one signal channel at a time of the selected optical signal. The method further includes a step of analyzing the selected optical channel of the selected optical signal and determining a signal quality of the selected optical channel.

Accordingly, the optical signal quality monitoring system and method of the present invention advantageously monitors the signal quality of multiple optical signals in a given network by analyzing each signal and provides Q-factor or bit error rate estimates for each signal. The present invention results in a small and reduced cost signal quality monitoring system that may be employed in various optical networks.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

FIG. 1 is a schematic diagram illustrating an optical cross-connect network element coupled to an optical network;

FIG. 2 is a block diagram illustrating an optical signal quality monitoring system according to the present invention;

FIG. 3 is a block diagram illustrating an optical signal channel selector according to a first embodiment;

FIG. 4 is a block diagram illustrating an optical signal channel selector according to a second embodiment;

FIG. 5 is a block diagram illustrating an optical signal channel selector according to a third embodiment;

FIG. 6 is a block diagram illustrating an optical signal channel selector according to a fourth embodiment; and

FIG. 7 is an optical signal channel selector according to a fifth embodiment.

### DETAILED DESCRIPTION OF THE PREFERRED EMBODIMENTS

An optical signal quality monitoring system is provided for monitoring optical signal quality of multiple optical signals in a network. According to the embodiment disclosed herein, the optical signal quality monitoring system monitors the optical signal quality of a plurality of optical signals in an optical network element, such as an optical cross-connect. However, it should be appreciated that the optical signal quality monitoring system of the present invention may be employed to monitor signal quality in any of a plurality of optical signals in a network containing any of a number of optical devices. The optical signal quality monitoring system includes a plurality of input taps for acquiring multiple optical signals from multiple optical fibers in a network, and an optical switch for receiving the tapped optical signals and selecting one of the tapped optical signals at a time as an output. The system also includes an optical channel selector for selecting one signal channel at a time of the selected optical signal. The system further includes an optical signal quality measurement device for analyzing the selected optical channel of the selected optical signal and determining a signal quality of the selected optical channel.

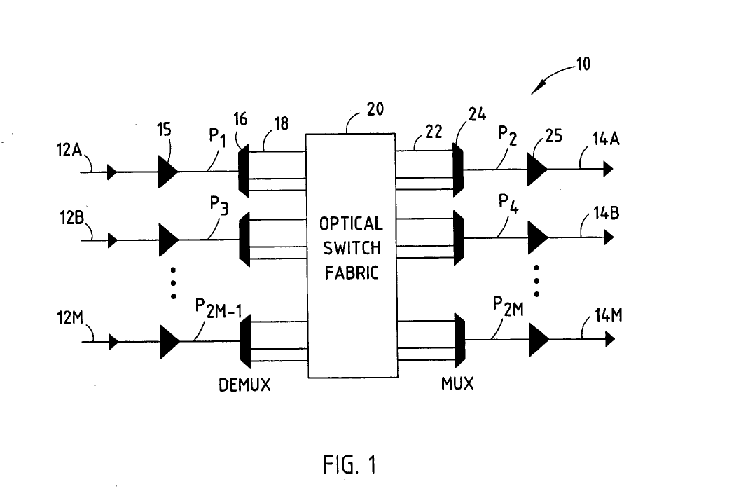

Referring to FIG. 1, a portion of an optical signal network is generally illustrated having an optical cross-connect network element 10 coupled between multiple input optical fibers 12A-12M and multiple output optical fibers 14A-14M. The optical cross-connect network element 10 is a switching network for switching digital data present on optical channels amongst a plurality of optical fibers. The input optical fibers 12A-12M each transmit optical signals that may include a plurality of signal channels. The output optical fibers 14A-14M likewise each transmit optical signals that may include a plurality of signal channels. The signal channels transmitted on input optical fibers 12A-12M may be interchangeably switched amongst any of the output optical fibers 14A-14M by way of the cross-connect network element 10. Also shown in the optical network are amplifiers 15 that compensate for optical fiber losses and amplifiers 25 that compensate for losses experienced in the cross-connect network element 10.

The optical cross-connect network element 10, in the embodiment shown, includes demultiplexers 16 coupled to each of input optical fibers 12A-12M to demultiplex the signal channels present on each optical fiber. The demultiplexer 16 generates a plurality of demultiplexed signals 18 which are separated based on wavelength. The cross-connect network element 10 also includes an optical switch fabric 20 for receiving the plurality of demultiplexed optical signals 18 and for providing selected switching to route certain of the demultiplexed optical signals 18 to a plurality of output signals 22 which, in turn, are directed to multiplexers 24. The multiplexers 24 each recombine the selectively switched demultiplexed signals 22 into a single multiplexed optical signal for transmission on the corresponding output optical fibers 14A-14M. It should be appreciated that other optical cross-connect elements may be employed with or without the demultiplexers and multiplexers.

Also shown in FIG. 1 are a plurality of input taps P₁-P_{2M} for acquiring optical signals from multiple locations in the network. For example, input tap P₁ acquires the optical signal present on optical fiber 12A, while input tap P₂ acquires the optical signal present on output optical fiber 14A. According to one embodiment, the input taps P₁-P_{2M} acquire a small amount of optical energy, such as in the range of one to five percent (1-5%) of the total optical signal, sufficient to monitor signal quality of the optical signal. By monitoring the optical signals at both the inputs and outputs of a given device, such as the cross-connect network element 10, the optical performance of the cross-connect network element 10 can be determined.

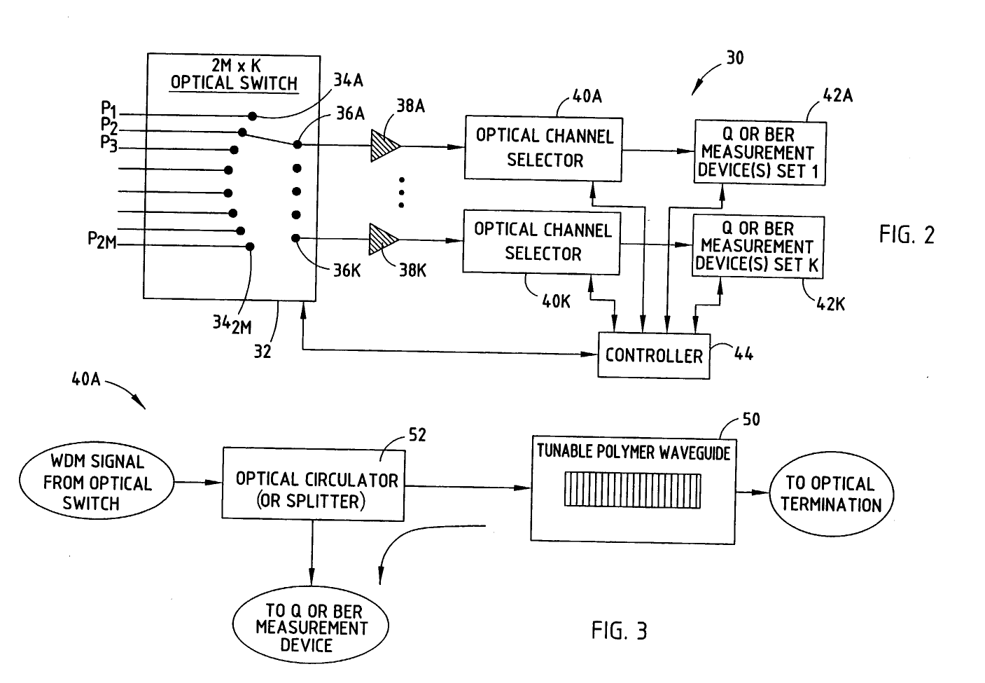

Referring to FIG. 2, an optical signal monitoring system 30 is illustrated for monitoring the signal quality of optical signals in an optical network. The optical signal monitoring system 30 includes an optical switch 32 having inputs 34A-34_{2M} for receiving optical signals acquired by each of input taps P₁-P_{2M}, respectively. The optical switch 32 is a 2M×K switch having 2M inputs 34A-34_{2M} and K outputs shown by output lines 36A-36K. Accordingly, the optical switch 32 is able to select optical input signals from any of 2M input lines 34A-34_{2M} and direct the selected signal to any of K output lines 36A-36K. The optical switch 32 may include any one of optimechanical switches, liquid crystal switches, and micro-electrical-mechanical (MEMs) switches. The optical switch 32 preferably has a fast switching time on the order of approximately fifty milliseconds or less.

The output lines 36A-36K of optical switch 32 are coupled to amplifiers 38A-38K, which, in turn, are coupled to inputs of optical channels selectors 40A-40K, respectively. Accordingly, the amplified optical signal on switched output 36A is input to optical channel selector 40A, and output 36K is input to optical channel selector 40K. Each optical channel selector selects one optical signal channel at a time. It should be appreciated that the optical signal monitoring system 30 may be implemented without amplifiers 38A-38K.

Each of the optical channel selectors 40A-40K are coupled to measurement devices 42A-42K, respectively. Each of the measurement devices 42-42K measures at least one of the Q-factor and bit error rate (BER) of selected optical channel as determined by the corresponding one of optical channel selectors 40A-40K. The measurement devices 42A-42K may include any of a number of known optical signal quality measuring devices that analyze the optical signal and determine a signal quality of the selected optical channel. According to one embodiment, the measurement devices 42A-42K may include a standard optical receiver with signal processing capability for analyzing the bit parity information (BIP-8 bytes contained in data frame headers such as, for example, SONET or SDH signals) in order to count errors to directly measure the bit error rate. In this example, at least one measurement device may be needed for each signal bit rate and data format present in the network. The measurement time could also be relatively long due to the long period of time required to count sufficient bit errors to reliably estimate the bit error rate. However, if the use of forward error correction (FEC) is employed by the network, the measuring devices 42A-42K may be receivers with forward error correction decoding circuitry. In this case, the forward error correction decoding circuitry may be employed to output a count of the number of errors corrected by the forward error correction, which then yields a bit error rate of the raw uncorrected signal. Since the raw bit error rate may be as high as 10⁻⁴, the required measurement time may be significantly reduced from the case in which the forward error correction is not used.

According to another embodiment, the measurement devices 42A-42K each may include an optical receiver with appropriate clock recovery electronics and signal processing capability to construct and analyze histograms of the received sampled bits at the bit center locations in order to estimate the signal Q-factor and bit error rate. The construction on analysis of histograms is well-known in the art, as evidenced by the article entitled “Optical Signal Quality Monitor Using Direct Q-Factor Measurement,” published by S. Ohteru and N. Takachio in IEEE Photonics Technology Letters, Vol. 11, page 1307, 1999, which is hereby incorporated herein by reference. In this embodiment, at least one measurement device may be required for each signal bit rate present in the network, but different data formats with the same bit rate may be handled by the same receiver. According to this embodiment, measurement times might be significantly shorter than that experienced with the error counting technique, since histograms with adequate statistics can be generated in a short time period for most common bit rates.

According to a further embodiment, the measurement devices 42A-42K may employ a receiver with clock recovery and a well-known Q fitting algorithm commonly used in laboratory settings to estimate the signal Q-factor. The Q fitting algorithm measures the signal bit error rate as a function of threshold decision voltage level, and then fits curves to the measured data and calculates the Q-factor under the assumption of Gaussian noise statistics. One example of a measuring device of this type utilizes two threshold decision circuits in the receiver, one of which is fixed near the center of the eye diagram, and the other of which is variable. Comparison of the digital output of the two decision circuits yields bit error rate values for the different threshold levels of the variable threshold decision circuit, and then this data of bit error rate as a function of variable threshold circuit voltage can be analyzed with the Q fitting algorithm to estimate the Q-factor. One example of signal quality measurement device of this type is described in U.S. Pat. No. 6,430,713 issued on Aug. 6, 2002, which is hereby incorporated herein by reference.

According to yet a further embodiment, the measurement devices 42A-42K may include an optically transparent monitoring solution that does not rely on the clock synchronization requirements of a standard receiver. According to this embodiment, each of the measuring devices 42A-42K can estimate the signal Q-factor and/or bit error rate for digital signals having any bit rate and data format. This type of a measurement device is well-known as an asynchronized sampling histogram based Q measurement device and could use a single device of this type to monitor all signals in the network at that location, such as the optical cross-connect network element. According to this embodiment, it may be possible for the monitoring system 30 to utilize only one optical channel selector.

The optical channel selectors 40A-40K may include any of a number of embodiments of an optical channel selector as shown in FIGS. 3-7. Referring to FIG. 3, an optical channel selector 40A is shown according to a first embodiment employing an optical circulator 52 and a tunable polymer waveguide 50 including a Bragg grating filter. The optical channel selector 40A is a tunable optical filter that selects only a single optical channel for transmission to the corresponding measurement device. The tunable polymer waveguide Bragg grating filter 50 enables low cost fabrication, is able to be mass produced, has low power consumption, and has a filter selection function that can be designed for different channel spacings with enhanced characteristics such as a flat top and steep side walls that make it very useful for a single channel selection with minimal distortion and adjacent channel crosstalk. The Bragg grating filter 50 operates to reflect only a single channel (frequency range) back through the optical circulator 32 for passage to the Q-factor or bit error rate measurement device. In lieu of an optical circulator 52, it should be appreciated that a splitter may be employed to pass the reflected signal within the selected single channel (frequency range) to the measurement device. The channel selector 40A according to the first embodiment assumes that the tuning range of the Bragg grating filter 50 is wide enough to cover all optical channels within a given optical fiber. The optical signal outside of the single optical channel that is not reflected by the tunable waveguide 50 passes to an optical termination and, thus, is effectively dumped. However, it should be appreciated that the optical signal not reflected by the waveguide 50 may be transmitted back into an optical fiber or device.

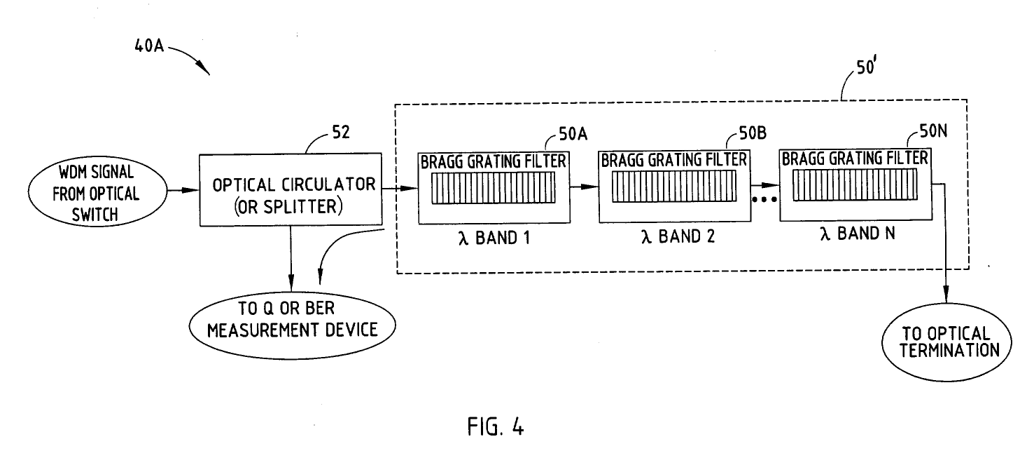

The optical channel selector 40A is shown in FIG. 4 according to a second embodiment having a tunable polymer waveguide 50′ employing a plurality of serial connected Bragg grating filters 50A-50N. Each of Bragg grating filter 50A-50N provides a distinct tuning range shown by wavelength band 1 through band N. In this embodiment, only one tunable filter is configured to drop a given channel at any time, while the other filters are tuned to drop different channels. The optical channel selector 40A according to the second embodiment enables the tunable waveguide 50 to cover a wider overall tuning range. The number N of Bragg grating filters in a typical application may be N equals two or three in order to cover a desired wavelength range of many optical networks.

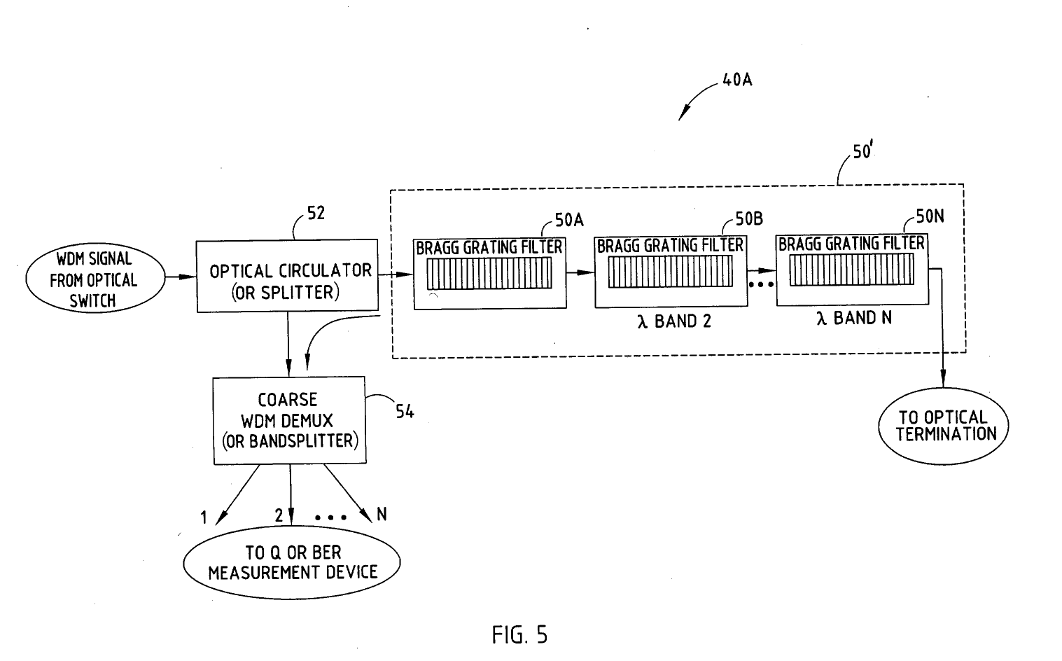

The optical channel selector 40A is further shown according to a third embodiment in FIG. 5 employing the tunable polymer waveguide 50′ with a plurality of tunable Bragg grating filters 50A-50N coupled in series as described above, and further including a course wavelength division multiplexed (WDM) demultiplexer 54. The WDM demultiplexer 54 directs the N different optical channels to different measurement devices to allow for simultaneous analysis of all N signal channels. In lieu of the course WDM demultiplexer 54, it should be appreciated that a band splitter may be used to direct the N different optical channels to N different measurement devices for simultaneous analysis of multiple channels.

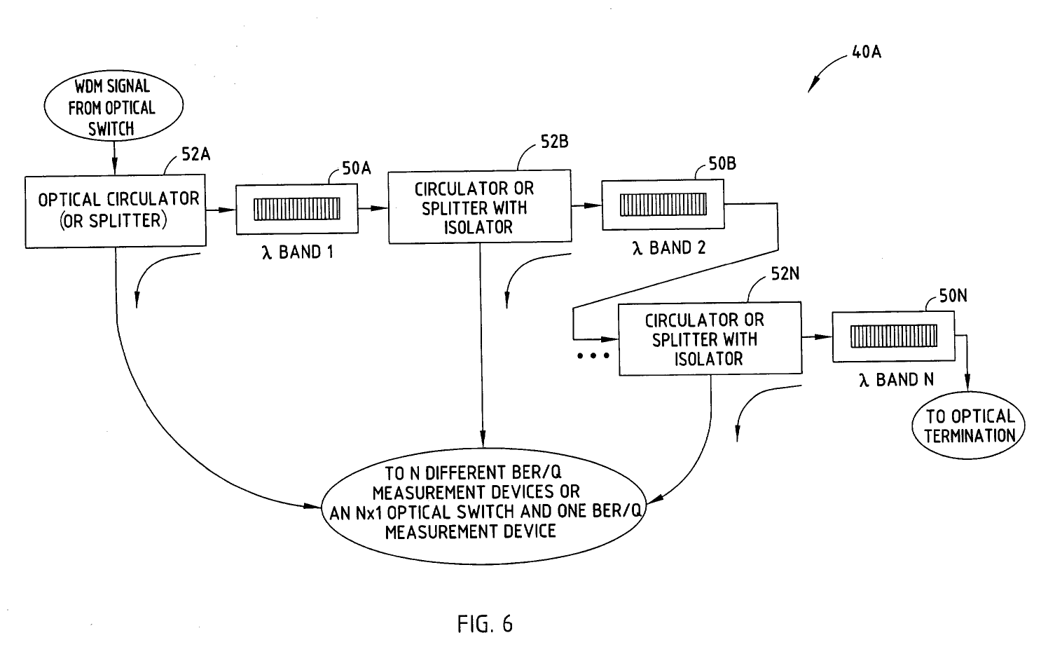

The optical channel selector 40A is further shown in FIG. 6 according to a fourth embodiment. According to the fourth embodiment, the optical channel selector 40A includes a plurality of tunable waveguides 50A-50N each made up of a tunable Bragg grating filter and arranged in series and having optical circulators 52A-52N, or alternately splitters, used to drop the N optical channels in parallel to either N different measurement devices or an N×1 optical switch and then to a single bit error rate/Q-factor measurement device.

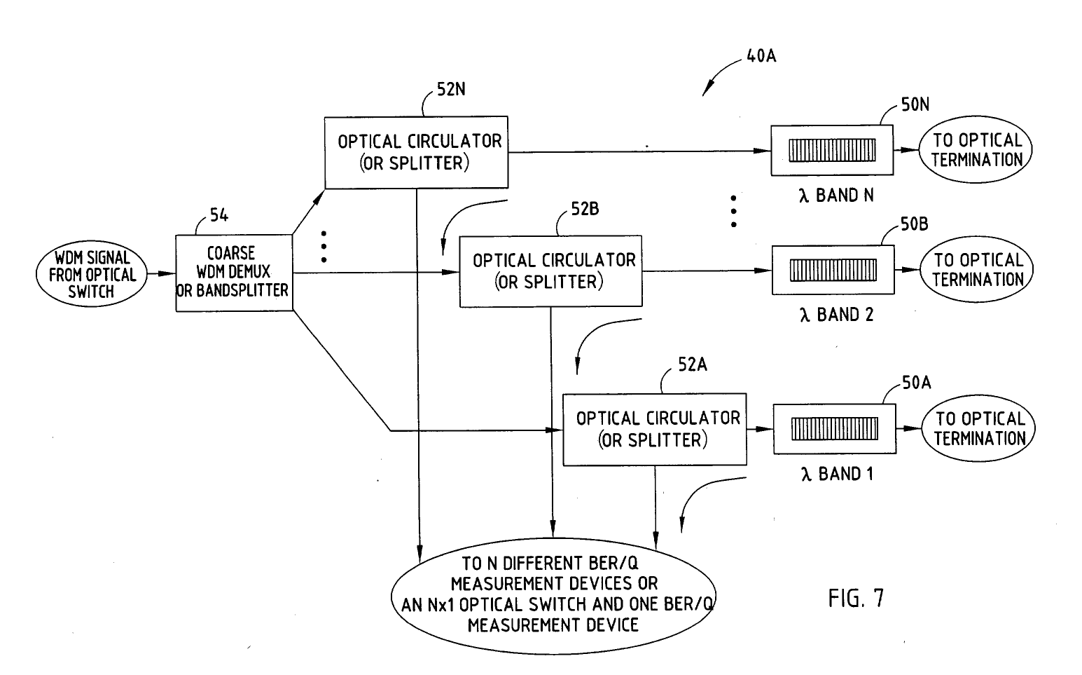

Finally, the optical channel selector 40A is shown according to a fifth embodiment illustrated in FIG. 7 in which the wavelength division multiplex signal is split into wavelength band 1 through band N by a course wavelength division multiplex (WDM) demultiplexer 52A-52N, or alternately a band splitter. Tunable filters 50A-50N then select a single channel out of each band 1-band N such that N channels are dropped in parallel. The N channels may then be directed to N different bit error rate/Q-factor measurement devices, or to an N×1 optical switch and then to a single bit error rate/Q-factor measurement device.

Accordingly, the optical signal quality monitoring system 30 of the present invention advantageously monitors signal quality of a plurality of optical signals in an optical network. The monitoring system 30 is substantially non-intrusive and allows implementation in optically transparent network elements, such as the optical cross-connect network element 10. The monitoring system 30 further allows sequential or on-demand monitoring of all optical channels and all optical fibers present at a given network location. Such a monitoring system 30 can potentially reduce cost associated with the transmission and monitoring of optical signals.

It will become apparent to those skilled in the art that various modifications to the preferred embodiment of the invention as described herein can be made without departing from the spirit or scope of the invention as defined by the appended claims.

The invention claimed is:

1. An optical signal quality monitoring system for monitoring signal quality of multiple optical signals in a network, said system comprising:
a plurality of input taps for acquiring multiple optical signals from multiple optical fibers in a network;
an optical switch for receiving the tapped optical signals and selecting one of the tapped optical signals at a time as an output;
an optical channel selector for selecting one signal channel at a time of the selected optical signal; and
an optical signal quality measurement device for analyzing the selected optical channel of the selected optical signal and determining a signal quality of the selected optical channel.

2. The system as defined in claim 1, wherein the optical switch provides a plurality of selectable switch outputs, each of said selectable switch outputs being provided to corresponding optical signal selectors and measurement devices for determining signal quality of a plurality of optical channels.

3. The system as defined in claim 1, wherein the measurement device measures at least one of a bit error rate and Q-factor of the selected optical channel.

4. The system as defined in claim 3, wherein the measurement device analyzes histograms of received bits in order to estimate the at least one of the bit error rate and Q-factor of the selected optical channel.

5. The system as defined in claim 1, wherein the tunable optical filter comprises a tunable polymer waveguide.

6. The system as defined in claim 5, wherein the tunable polymer waveguide comprises a Bragg grating filter.

7. The system as defined in claim 5, wherein the tunable polymer waveguide comprises a plurality of tunable filters for selecting wavelength bands.

8. The system as defined in claim 1, wherein the plurality of taps are coupled to an optical cross-connect network element.

9. The system as defined in claim 1, wherein the plurality of taps include a first optical tap at the input of an optical device and a second optical tap at an output of the optical device, wherein the measuring device measures the signal quality of the optical signal at the input and output of the optical device.

10. An optical signal quality monitoring system for monitoring signal quality of a plurality of optical signals in an optical cross-connect network, said system comprising:
a plurality of input taps for acquiring multiple optical signals for multiple optical fibers in an optical cross-connect network;
an optical switch for receiving the tapped optical signals and selecting one of the tapped optical signals at a time as an output;
an optical channel selector for selecting one signal channel at a time of the selected optical signal; and
an optical signal quality measurement device for analyzing the selected optical channel of the selected optical signal and determining a signal quality of the selected optical channel.

11. The system as defined in claim 10, wherein the optical switch provides a plurality of selectable switch outputs, each of said selectable switch outputs being provided to corresponding optical signal selectors and measurement devices for determining signal quality of a plurality of optical channels.

12. The system as defined in claim 10, wherein the measurement device measures at least one of a bit error rate and Q-factor of the selected optical channel.

13. The system as defined in claim 12, wherein the measurement device analyzes histograms of received bits in order to estimate the at least one of the bit error rate and Q-factor of the selected optical channel.

14. The system as defined in claim 10, wherein the optical channel selector comprises a tunable polymer waveguide.

15. The system as defined in claim 14, wherein the tunable polymer waveguide comprises a Bragg grating filter.

16. The system as defined in claim 14, wherein the tunable polymer waveguide comprises a plurality of tunable filters for selecting wavelength bands.

17. The system as defined in claim 10, wherein the plurality of taps include a first plurality of taps coupled to input of the optical cross-connect network element, and a second plurality of taps coupled to outputs of the optical cross-connect network element.

18. The system as defined in claim 10, wherein the plurality of taps include a first optical tap at the input of an optical device and a second optical tap at an output of the optical device, wherein the measuring device measures the signal quality of the optical signal at the input and output of the optical device.

19. A method of monitoring signal quality of multiple optical signals in a network, said method comprising the steps of:
acquiring multiple optical signals from multiple optical fibers in a network;
selecting one of the tapped optical signals at a time;
selecting one optical channel of the selected optical signals at a time;
analyzing the selected optical channel of the selected optical signal; and
determining a signal quality of the selected optical channel.

20. The method as defined in claim 19 further comprising the step of:
selecting a second optical channel of the selected optical signal;
analyzing the selected second optical channel of the selected optical signal; and
determining a signal quality of the selected second optical channel.

21. The method as defined in claim 19 further comprising the step of:
selecting another one of the tapped optical signals at a time;
selecting one optical channel of the selected second optical signal;
analyzing the selected optical channel of the selected second optical signal; and
determining a signal quality of the selected optical channel of the selected second optical signal.

22. The method as defined in claim 19, wherein the step of selecting one of the tapped optical signals at a time comprises switching an optical switch.

23. The method as defined in claim 19, wherein a step of analyzing the optical signal comprises measuring at least one of a bit error rate and Q-factor of the selected optical channel.

24. The method as defined in claim 23, wherein the step of measuring comprises analyzing histograms of received bits in order to estimate the at least one of the bit error rate and Q-factor of the selected optical channel.

25. The method as defined in claim 19, wherein the step of selecting one signal channel comprises optical filtering with a tunable optical filter.
